(19) United States
(12) Patent Application Publication
(10) Pub. No.: US 2006/0031104 A1
(43) Pub. Date: Feb. 9, 2006

(54) System and method for optimizing insurance estimates

(76) Inventor: Raymond J. Gianantoni, Wilbraham, MA (US)

Correspondence Address: MCCORMICK, PAULDING & HUBER LLP, CITY PLACE II, 185 ASYLUM STREET, HARTFORD, CT, 06103, US

(21) Appl. No.: 10/914,678

(22) Filed: Aug. 9, 2004

(51) Int. Cl. G06Q 40/00

(52) U.S. Cl. 705/4

(57) ABSTRACT

A method for optimizing insurance estimates for an insurance plan includes ascertaining the number of insured units to be covered by the plan, and obtaining premium quotes from an insurance carrier, the premium quotes corresponding to the number of insured units and to a plurality of cap levels of the plan. The method further includes obtaining statistical loss data for the insured units and applying the obtained statistical loss data to each of the cap levels.

### FIELD OF THE INVENTION

The present invention relates to a system and method for optimizing insurance estimates. Specifically, the present invention involves a system and method for calculating expected losses of a group of potential insureds, and the projected savings for at least two stop-loss cap levels, to thereby assist employers in selecting an appropriate cap level when selecting stop-loss insurance.

### BACKGROUND OF THE INVENTION

Employers obtain health insurance funding in one of two ways. Employers may be either fully insured or self-insured. Fully insured employers pay a monthly premium to an insurance carrier to cover their employees' medical expenses. Being fully insured offers employers several benefits including known premiums that may be included in a budget, minimal financial risk and ease of plan administration.

Many employers, however, choose to self-insure rather than purchase group insurance plans to minimize their expenses. These employers typically set aside funds from which employees and their families are reimbursed for their medical expenses. Self-insured employers usually hire an administrator to process their employees' claims. While self-insurance is often an excellent cost-saving measure, it exposes employers to a high level of financial risk. If an employee incurs unexpectedly high medical expenses, an employer's medical reimbursement funds may be exhausted.

Stop-loss insurance minimizes this financial risk by reimbursing employers for medical expenses that exceed a certain deductible threshold, often referred to as a cap level. There are two types of stop-loss insurance, aggregate and specific. Aggregate stop-loss insurance reimburses an employer when all claims exceed an agreed upon cap level, typically described as a monthly amount per single employee and employee with family. The cap is usually expressed as a percentage of expected claims.

With specific stop-loss insurance, the carrier reimburses the employer when claims for an individual exceed a specified cap level in a plan year. The carrier reimburses the employer for the remainder of the plan year. Specific stop-loss insurance has different rates for single employees and for families. The rates are lower the higher the cap level at which the carrier begins reimbursing the employer.

While stop-loss insurance reduces financial risk for self-insured employers, it is an added expense. Therefore, employers contemplating such insurance must perform a detailed analysis to determine whether the benefit justifies the cost. Performing such an analysis, however, is often difficult as stop-loss insurance carriers do not provide expected losses to the employer. Stop-loss insurance carriers simply quote prices for different cap level, e.g., $50,000, $60,000 or $70,000 leaving the employer to determine whether self-insurance is the best option and, if so, the appropriate cap level of stop-loss insurance.

In light of the above, there exists a need for a source of factual information based on historical loss data which may be used by employers to select the appropriate cap level of stop-loss insurance. The present invention fulfills these needs and more.

### SUMMARY OF THE INVENTION

It is an object of the present invention to provide a system and method of optimizing insurance estimates that offers potential insurance purchasers information on the group to be insured from which they can make an informed decision as to an appropriate type and level of insurance coverage.

It is another object of the present invention to provide a system and method of optimizing insurance estimates that offers self-insured employers information based on historical insurance loss data which they can make an informed decision as to an appropriate cap level of stop-loss insurance coverage.

It is an additional object of the present invention to provide a system and method of optimizing insurance estimates that utilizes historical insurance loss data to determine a potential insurance purchaser's expected losses at various cap levels of stop-loss coverage.

It is yet another object of the present invention to provide a system and method of optimizing insurance estimates that utilizes computer software to calculate projected savings based on expected losses and the cost of annual premiums at various cap levels of stop-loss coverage and provide such information to potential insurance purchasers.

In accordance with a preferred embodiment of the present invention, a method for optimizing insurance estimates for an insurance plan includes ascertaining the number of insured units to be covered by the plan, and obtaining premium quotes from an insurance carrier, the premium quotes corresponding to the number of insured units and to a plurality of cap levels of the plan. The method further includes obtaining statistical loss data for the insured units and applying the obtained statistical loss data to each of the cap levels.

These and other objects and advantages of the present invention will become readily apparent upon further review of the following drawings and specification.

### BRIEF DESCRIPTION OF THE DRAWINGS

FIG. 1 is a schematic of one possible system, according to one embodiment of the present invention.

FIG. 2 is a flowchart illustrating the steps of an insurance optimizing method, according to one embodiment the present invention.

FIG. 3 is a flowchart illustrating the steps in determining projected savings to an employer of a group of potential insureds, in accordance with an insurance optimizing method of the present invention.

FIG. 4 is a table illustrating projected savings at multiple stop-loss cap levels according to an insurance optimizing method of the present invention.

FIG. 5 is a screen display depicting one possible implementation of an insurance optimizing method according to the present invention.

FIGS. 6-31 are additional screen displays depicting the implementation of the insurance optimizing method of FIG. 5.

### DETAILED DESCRIPTION OF THE PREFERRED EMBODIMENT

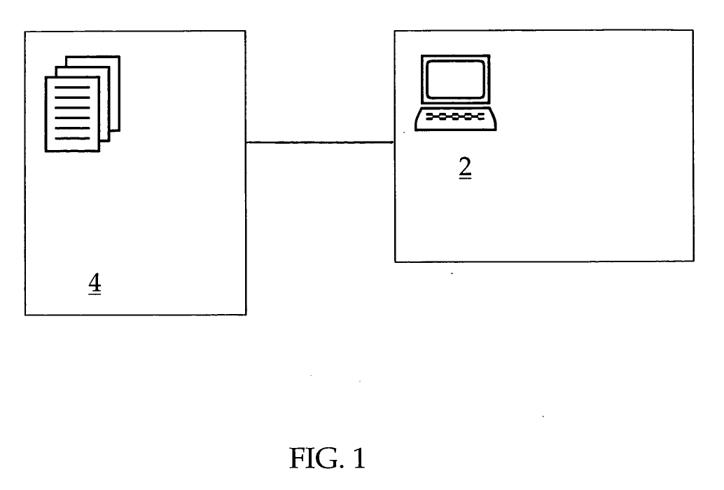

As shown schematically in FIG. 1, a system in accordance with an embodiment of the present invention includes a computer 2 and at least one database of insurance loss statistics 4. As discussed in greater detail below, the computer 2 contains software that calculates an employer's expected losses from historical loss statistics and compares the expected losses at each cap level of stop-loss insurance to annual premiums at each level. As will be appreciated, the insurance loss database 4 may be resident on the computer 2 or may be accessible via a network such as the Internet.

The insurance loss database 4 contains historical loss statistics. The statistics may include age, sex, geographic location, occupation and other relevant statistics of individual loss incurring insureds at well as the amount of each loss. The statistics also include whether the loss incurring insured was a single insured or family insured, referred to herein as single or family insured units. Third party companies typically compile these statistics. As will be appreciated, the loss statistics may be carrier specific or may be general industry statistics and may be an annual compilation or may represent a greater time period.

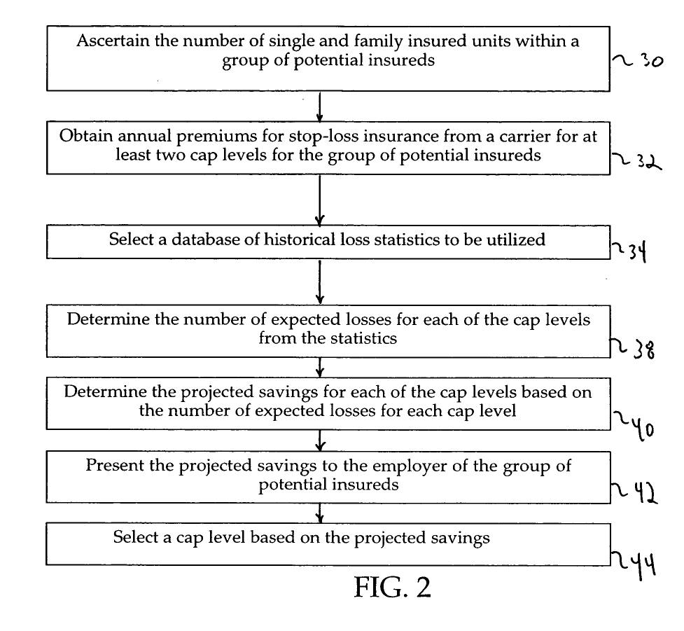

FIG. 2 is a flow chart indicating steps of a method of the present invention in optimizing stop-loss insurance estimates. Initially, the number of single and family insured units within the group of potential insureds is ascertained, as noted at 30. Determining the number of insured units is important in that premium costs differ between single and family insured units and most annual premiums are based on the numbers of each type of insured unit. Once the number of each type of insured unit is ascertained, the self-insured entity, also referred to as the employer, obtains a quote for annual premiums for stop-loss insurance as noted at 32. As will be appreciated, the self-insured entity may obtain a quote through a stop-loss insurance broker or directly from an insurance carrier.

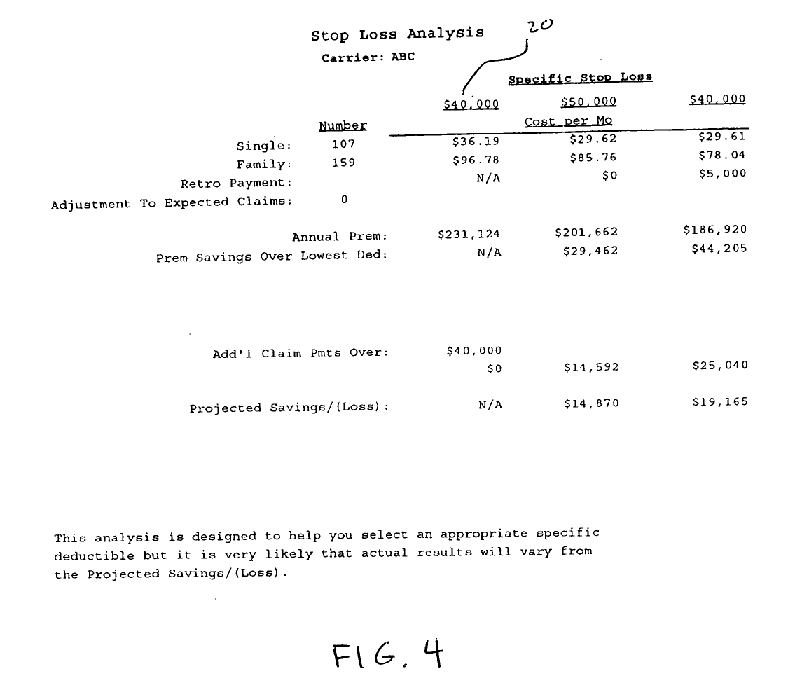

The quote must contain annual premiums for at least two cap levels of stop-loss insurance so that a comparison between the cap levels can be made. As mentioned above, the cap levels are the levels above which an insurance carrier must reimburse a self-insured entity for an insured unit's medical costs. Generally, the lower the cap, the higher the annual premium. Typically, such quotes will contain three cap levels. As shown in FIG. 4, and as will be appreciated, these cap levels 20 may increase by $10,000 or another amount.

The quotes may also contain a cap level that includes a retro payment, also referred to an aggregating specific quote. These cap levels typically require the self-insured entity to make an additional aggregate payment above a cap level before the carrier begins reimbursement for an individual exceeding the cap level. For example, a cap level of $40,000 with a $5,000 retro payment requires the employer to pay $40,000 of an individual's medical expenses plus $5,000 before the carrier begins reimbursement. However, multiple insured units may cumulatively satisfy the $5,000 payment and the retro payment is therefore aggregate. Additionally, the employer only need make the retro payment once and, after it has been satisfied, the employer only pays up to the cap level i.e., $40,000.

Returning to FIG. 2, after the annual premiums for at least two cap levels have been quoted, a database of historical loss statistics must be selected as noted at 34. The loss statistics may be carrier specific or may be general industry statistics. As discussed in greater detail below, the loss statistics are utilized to determine the number of expected claims over each cap level.

Once the loss database 4 has been chosen, the number of insured units whose annual medical claims exceeded each of the quoted cap levels is ascertained. Alternatively, statistics from the loss database may be selected based on the demographics of the group of potential insured units. That is, the number and amount of medical claims for insured units that are demographically similar to the group of potential insured units may be assessed.

After the database of loss statistics 4 has been selected and the number of insured units over the cap levels has been ascertained, the number of expected losses for each of the cap levels is determined as noted at 38. In this step, the number of expected insured units exceeding the cap levels, obtained from the loss statistics, is expressed as per 1000 insured units.

Step 38 is a critical aspect of the present invention. Stop-loss carriers and brokers today do not estimate expected losses at the various cap levels when providing quotes for stop-loss coverage. Stop-loss insurance carriers simply quote prices for different caps, e.g., $50,000, $60,000 or $70,000 leaving the employer to determine the appropriate level of stop-loss insurance. By utilizing historical loss data, the present invention facilitates the selection of an appropriate cap level of stop-loss insurance.

When the expected losses have been determined, this data is used to ascertain the projected savings at each cap level as recorded at 40. The projected savings represents the dollar amount that the self-insured entity would likely save for each cap level over the cap level with the highest annual premium. This is an additional important aspect of the present invention in that it allows employers to see projected dollar savings for the various cap levels based on the demographics of their employees. Thus, the employer can choose an appropriate cap level for its stop-loss insurance. As mentioned above, stop-loss carriers and brokers do not perform such an analysis or provide this information to employers.

As noted at 42 and 44, once the projected savings at the various cap levels has been determined, the data is then presented to the employer of the group of potential insured units. The employer can then make an informed selection of an appropriate stop-loss cap level.

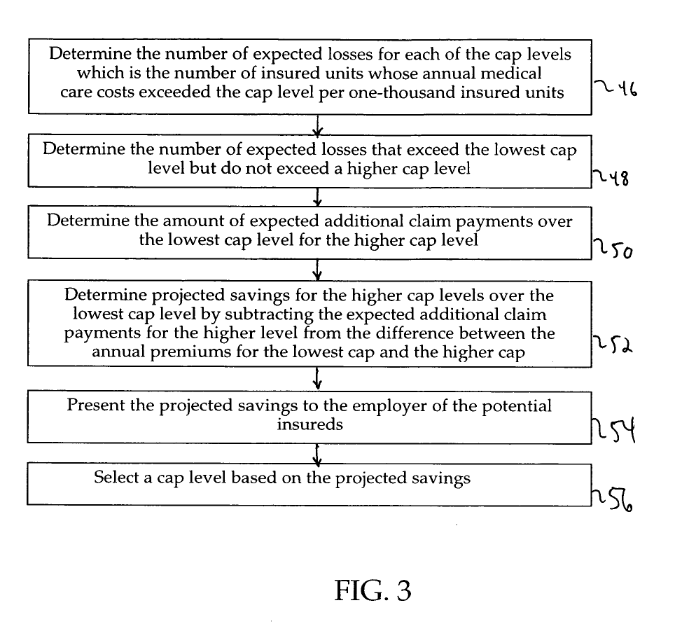

Turning now to FIG. 3, the steps by which the projected savings for a certain cap level is determined are described in greater detail. As noted at 46, the number of expected losses is first ascertained. This is the number of insured units whose annual medical care costs exceeded each cap level per 1000 insured units. Using the expected losses per cap level, the number of expected losses that exceed a lower cap level but do not exceed a higher cap level whose projected savings are to be assessed, are determined as noted at 48.

As noted at 50, the dollar amount of additional claim payments, over the lower cap level, is determined for the higher cap level. To determine additional claim payments, the number of insured units whose claims exceeded the lower cap level but did not exceed the higher cap level is multiplied by the dollar difference between the lower and higher cap levels. Additionally, any required retro payment would be factored in as well. So, the expected losses over the cap level requiring a retro payment are multiplied by the amount of the retro payment. This sum is then added to the product of the number of insured units whose claims are above the lower cap level but are under the higher cap level and the dollar difference between the lower and higher cap levels. In this way, the expected retro payments are factored into the amount of additional claim payments for the higher cap level.

Turning to step 52, the expected additional claim payments for the higher level is subtracted from the dollar difference between the premium costs for the lower and higher cap levels. This results in the projected savings for the higher cap level.

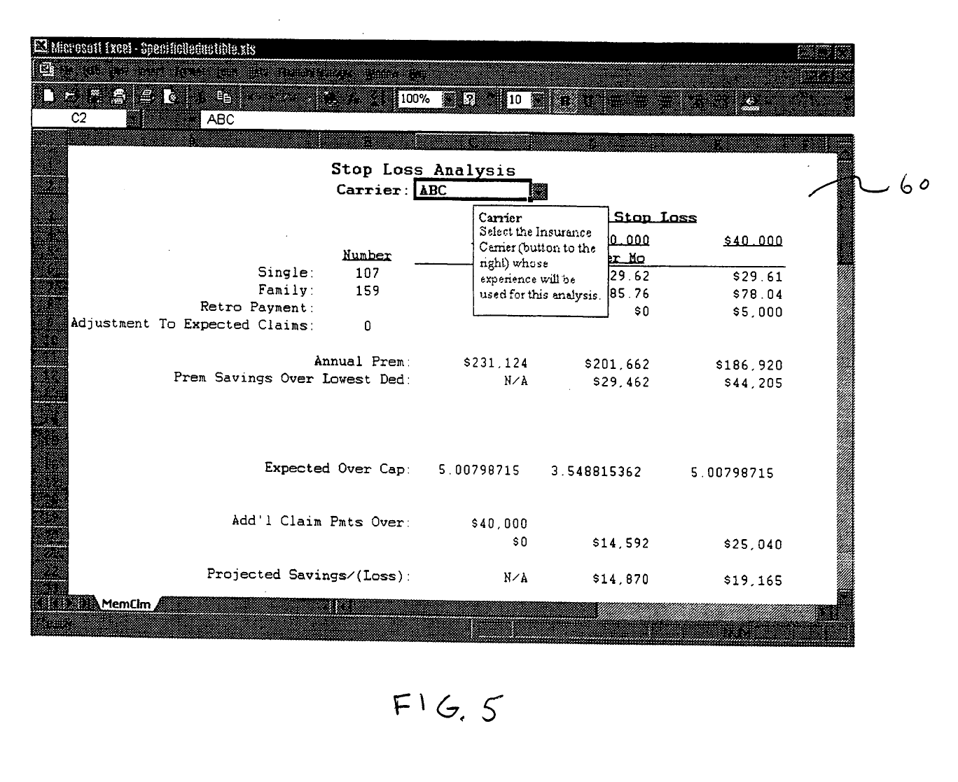

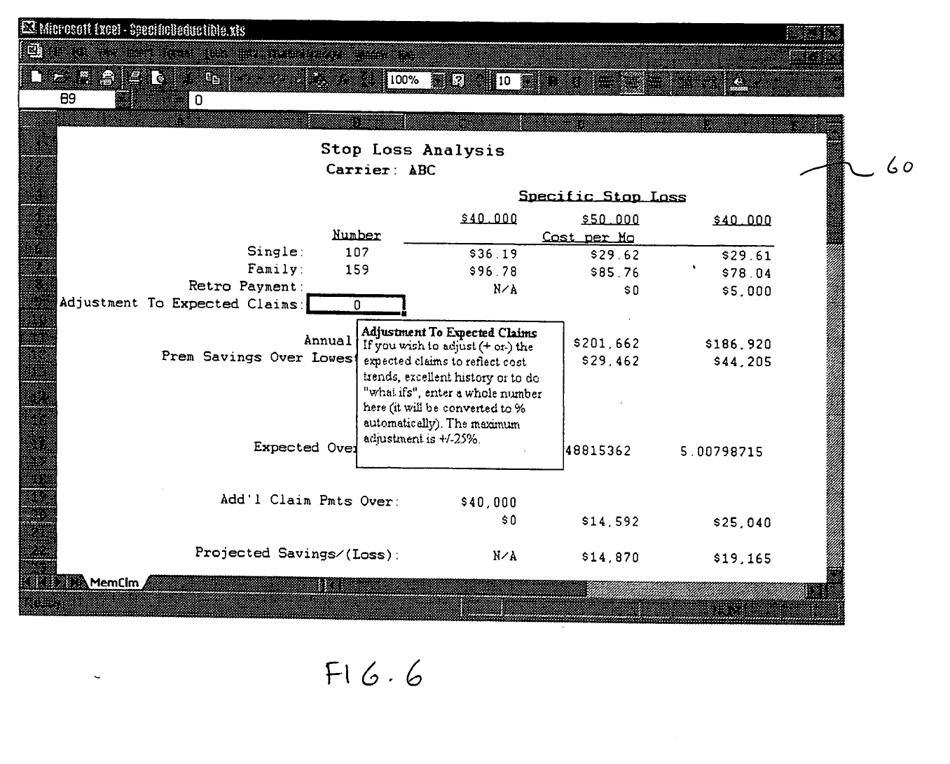

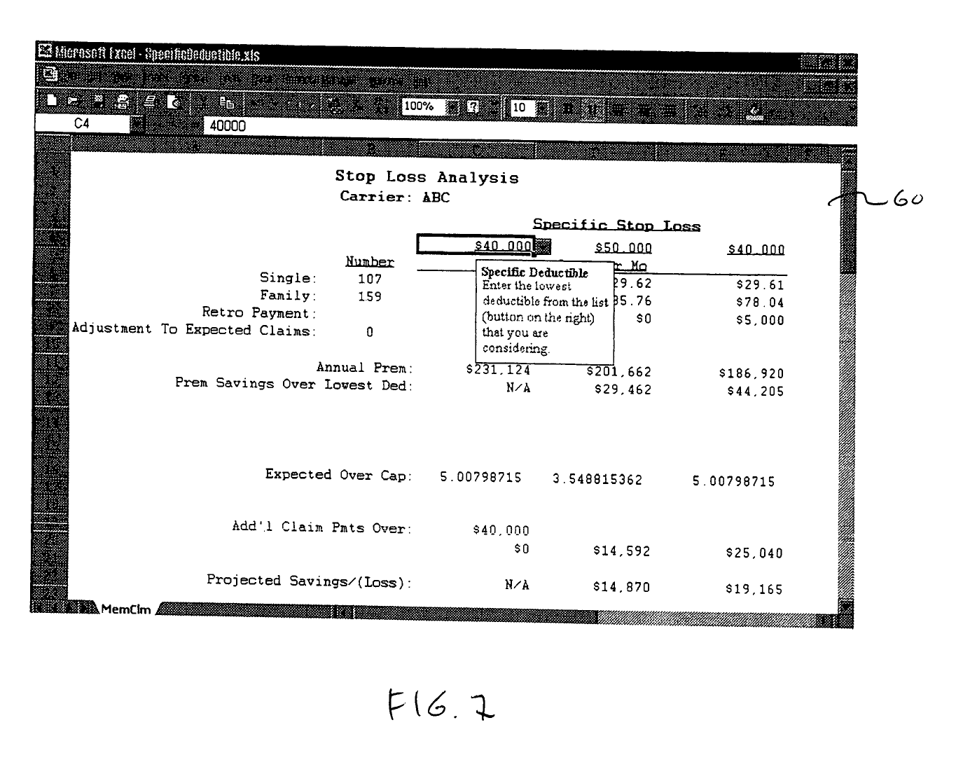

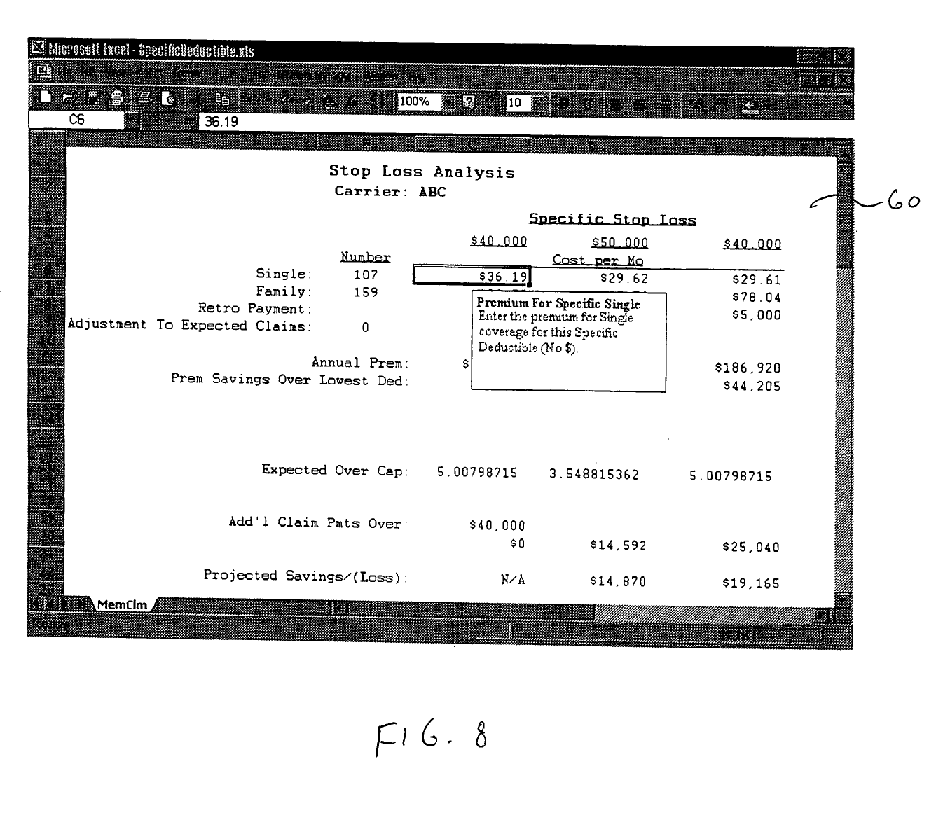

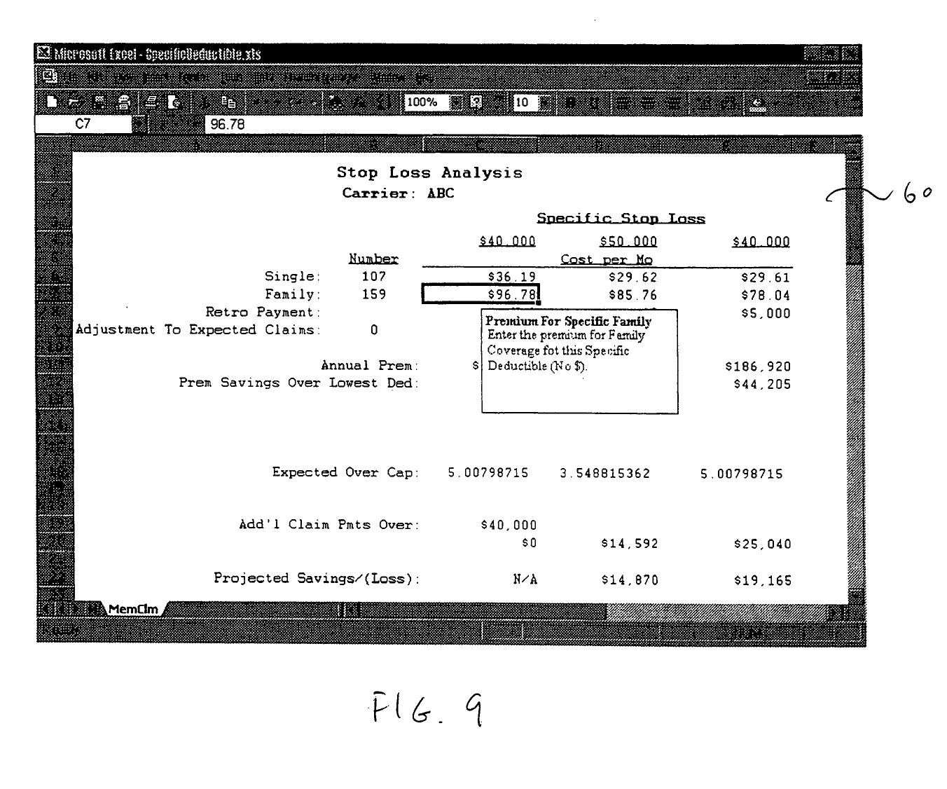

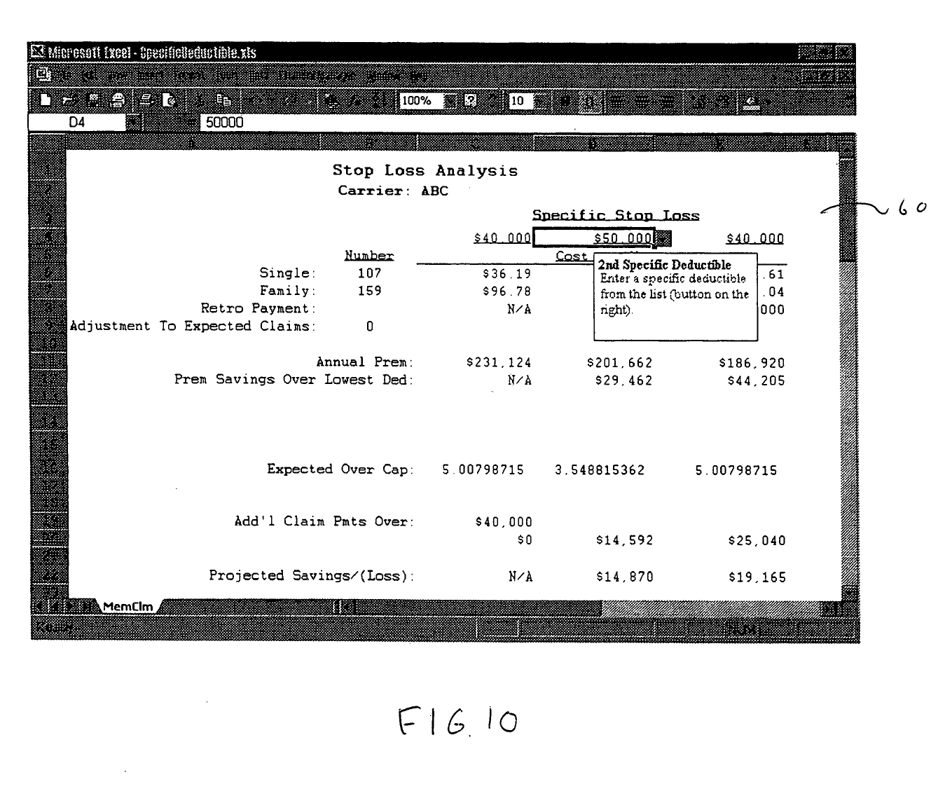

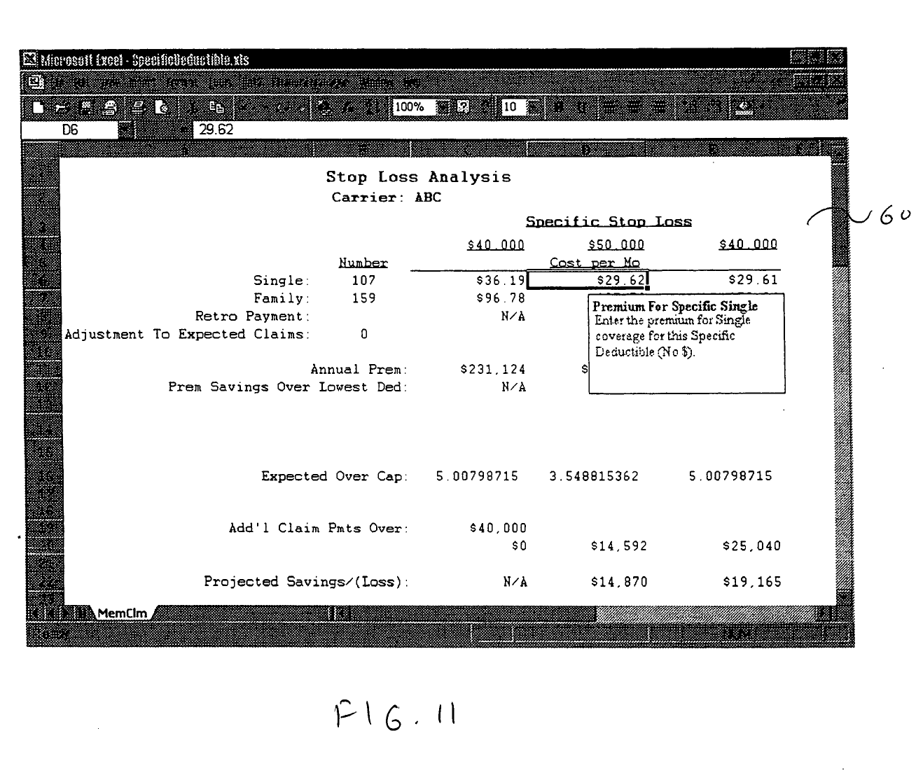

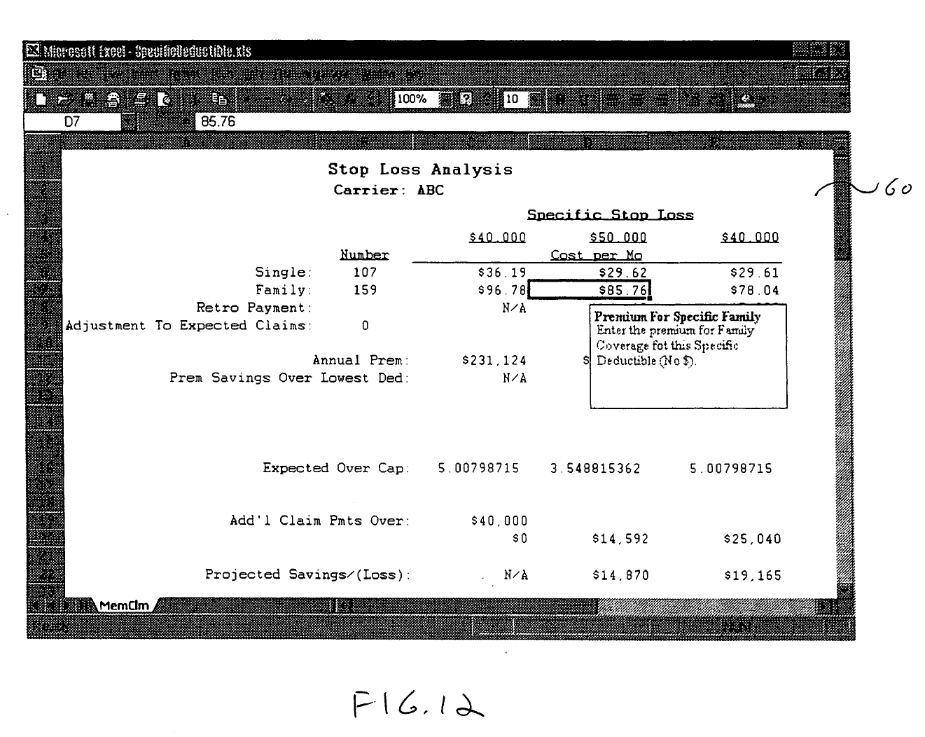

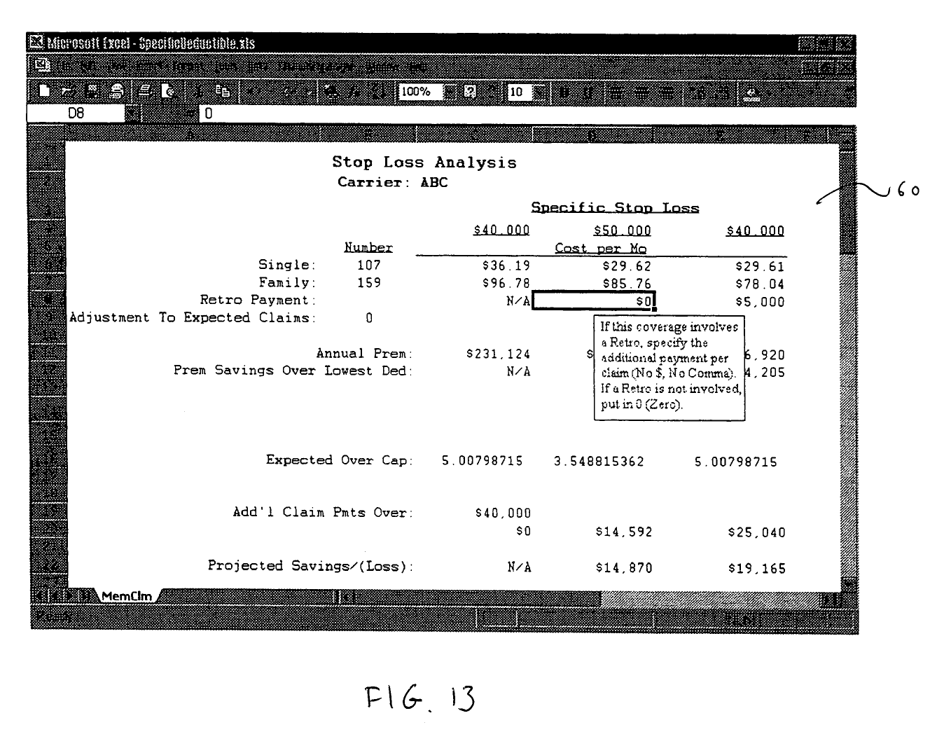

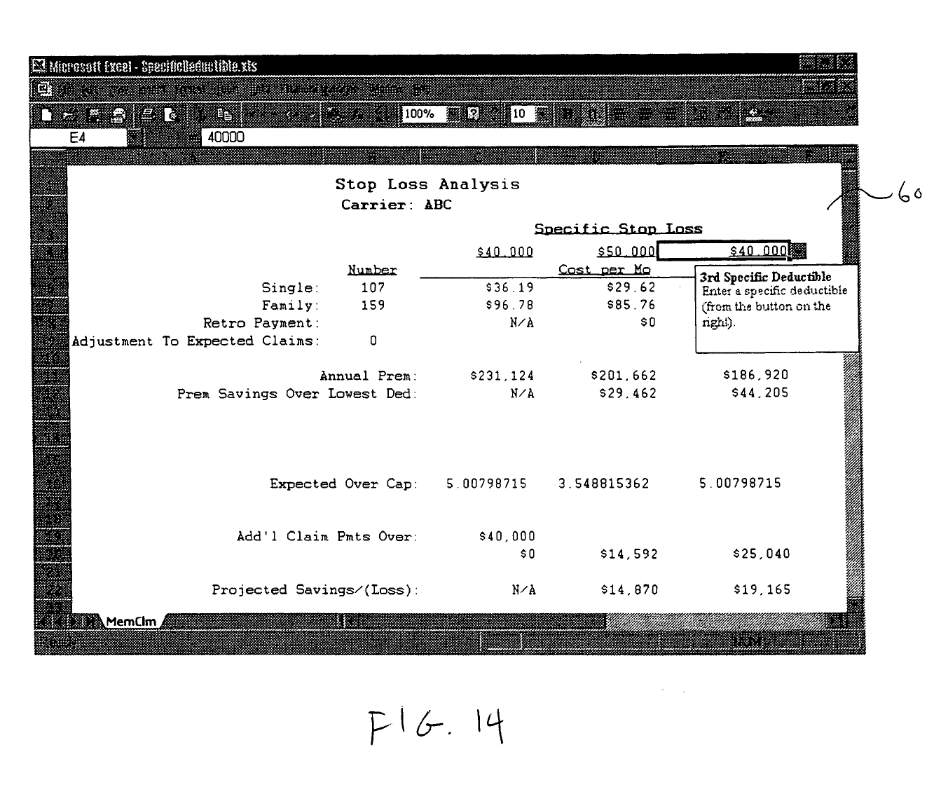

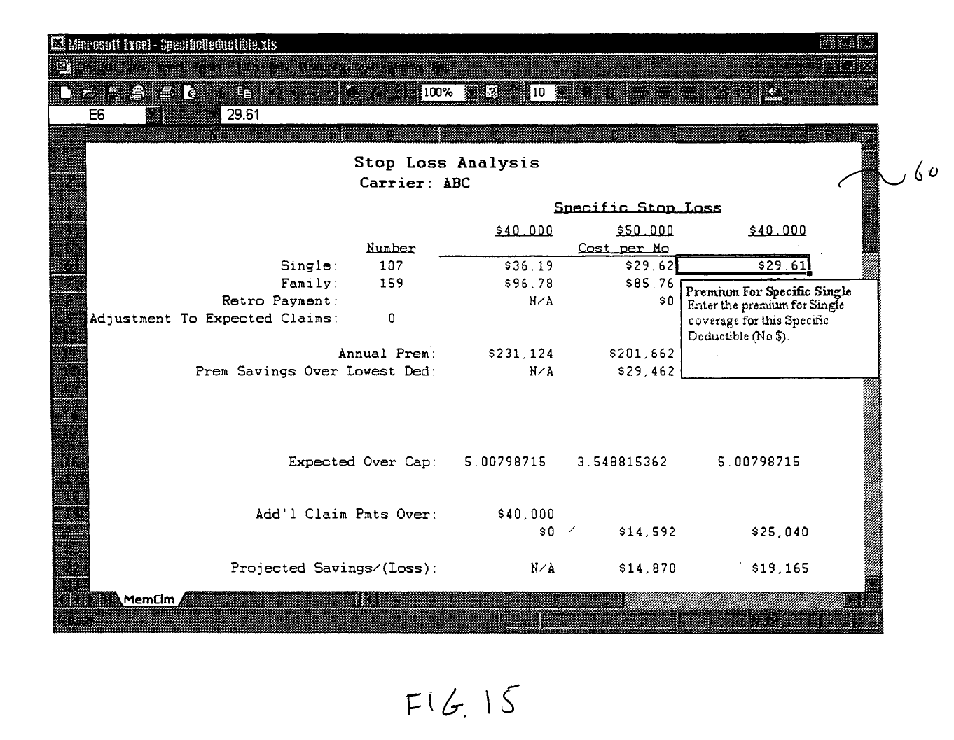

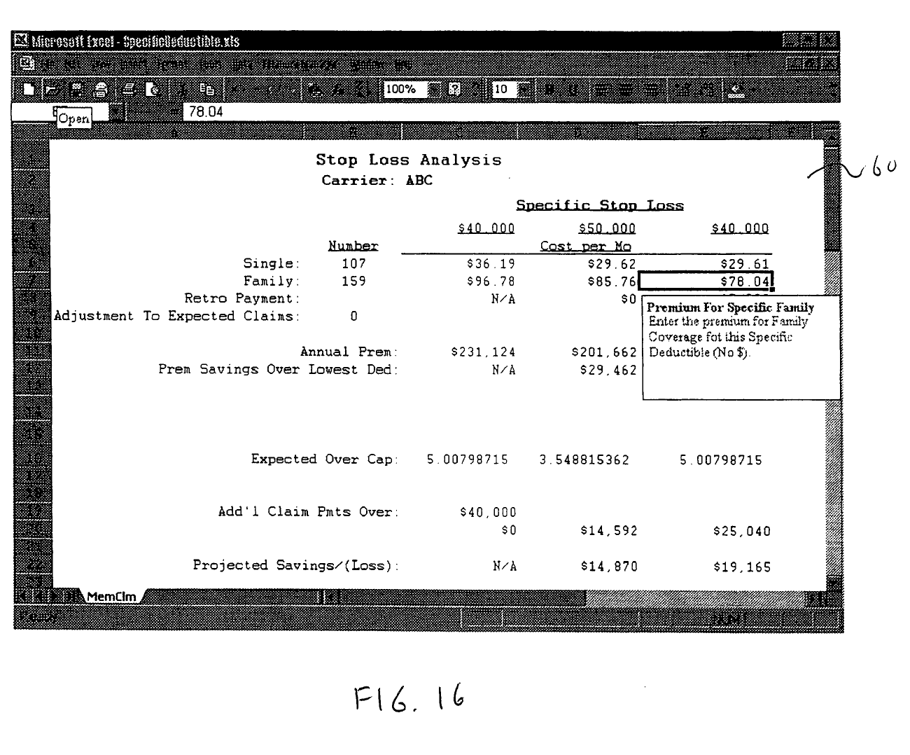

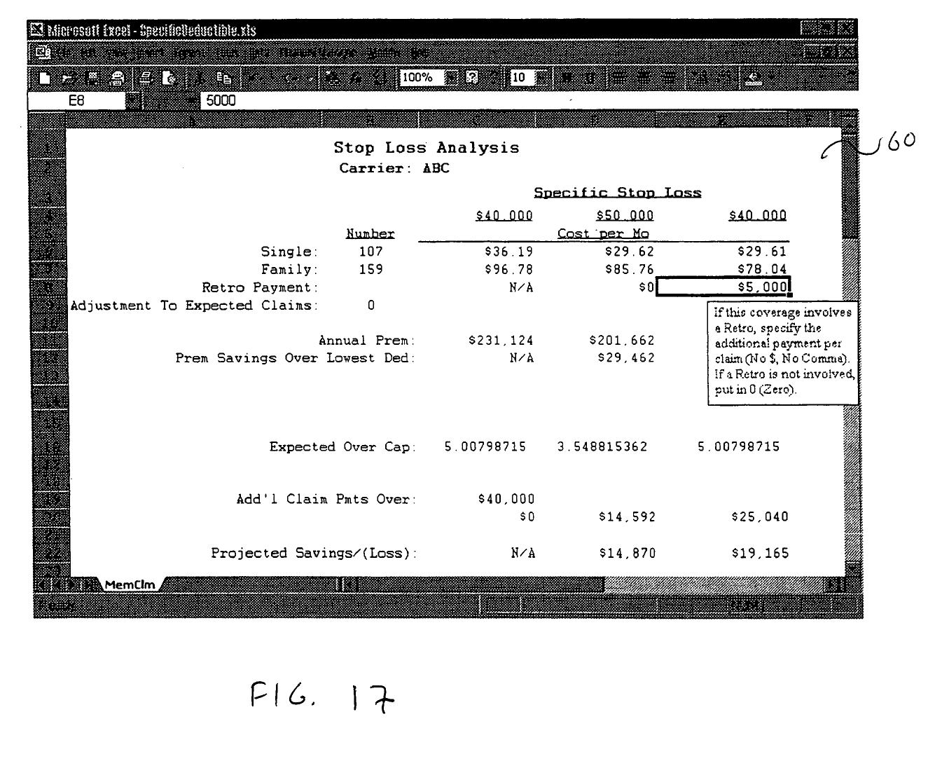

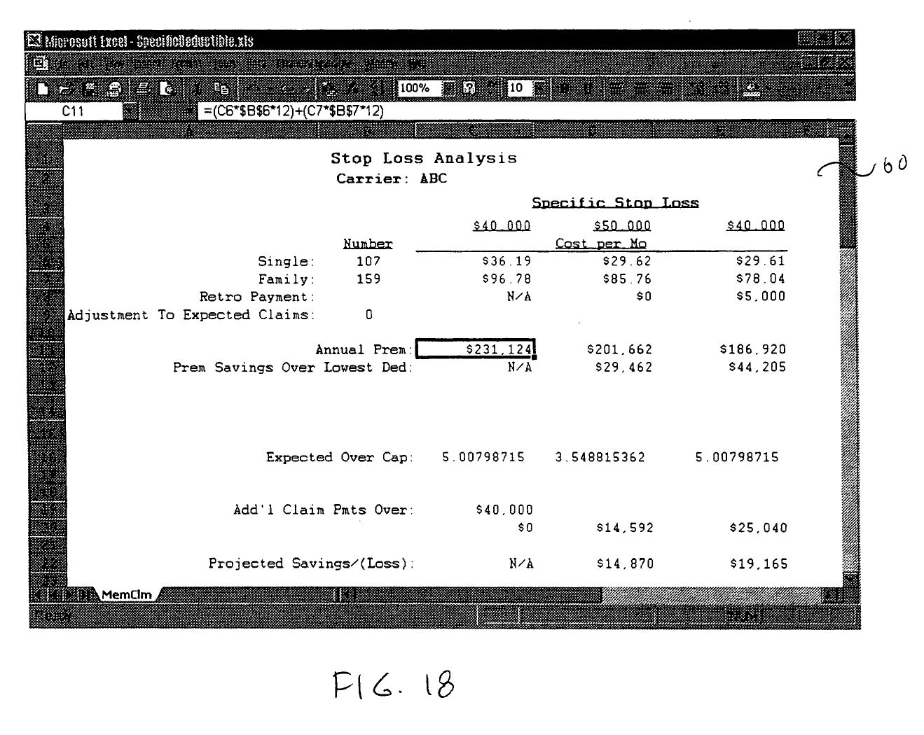

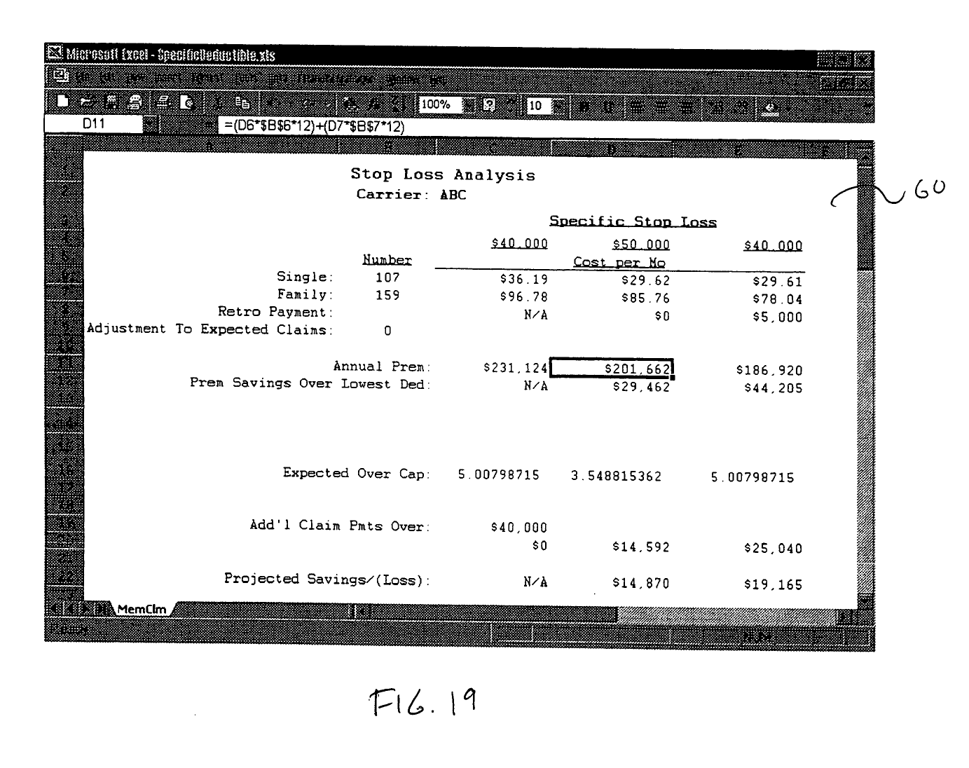

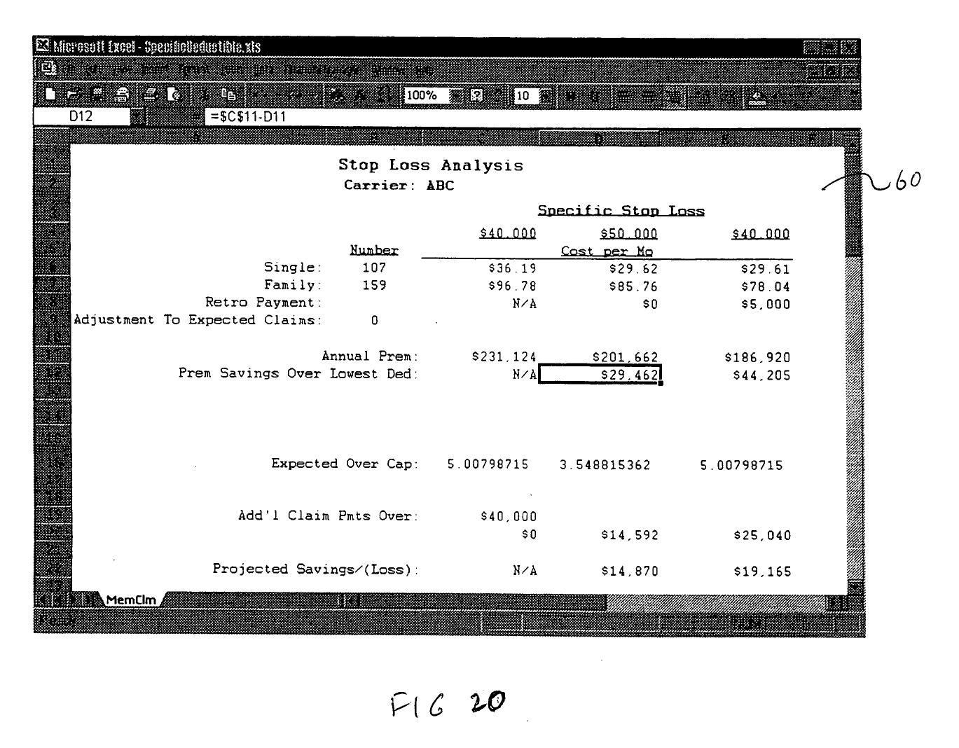

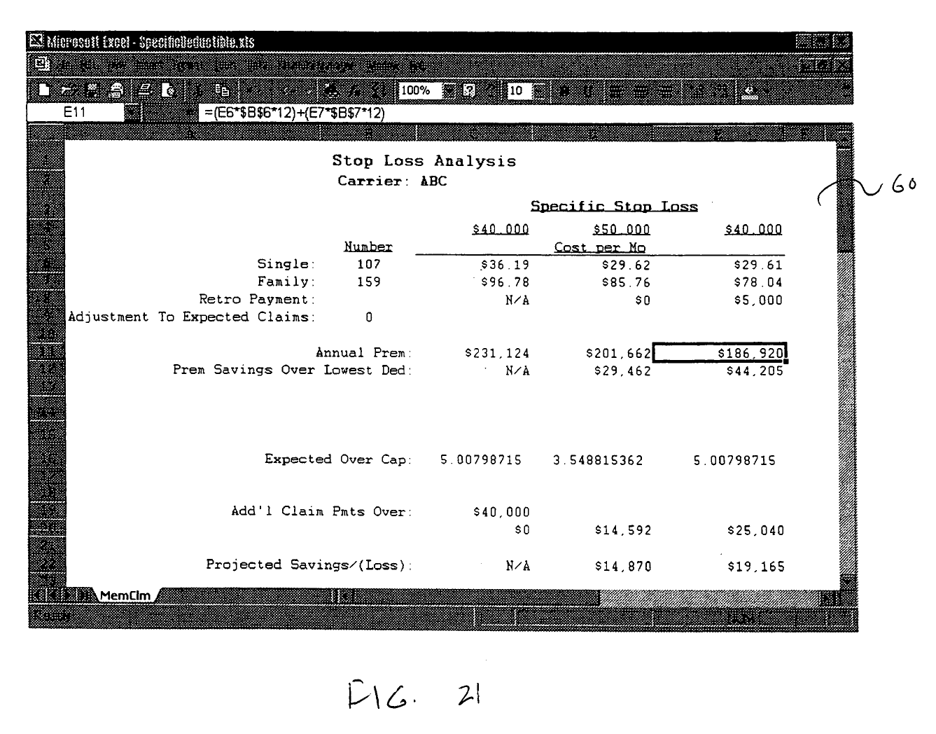

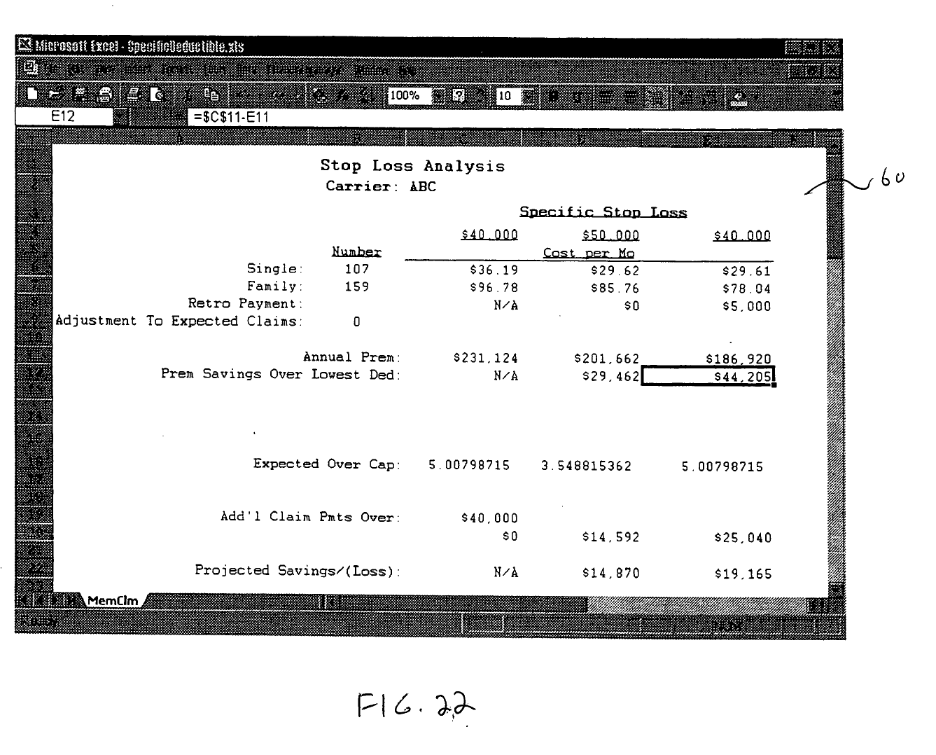

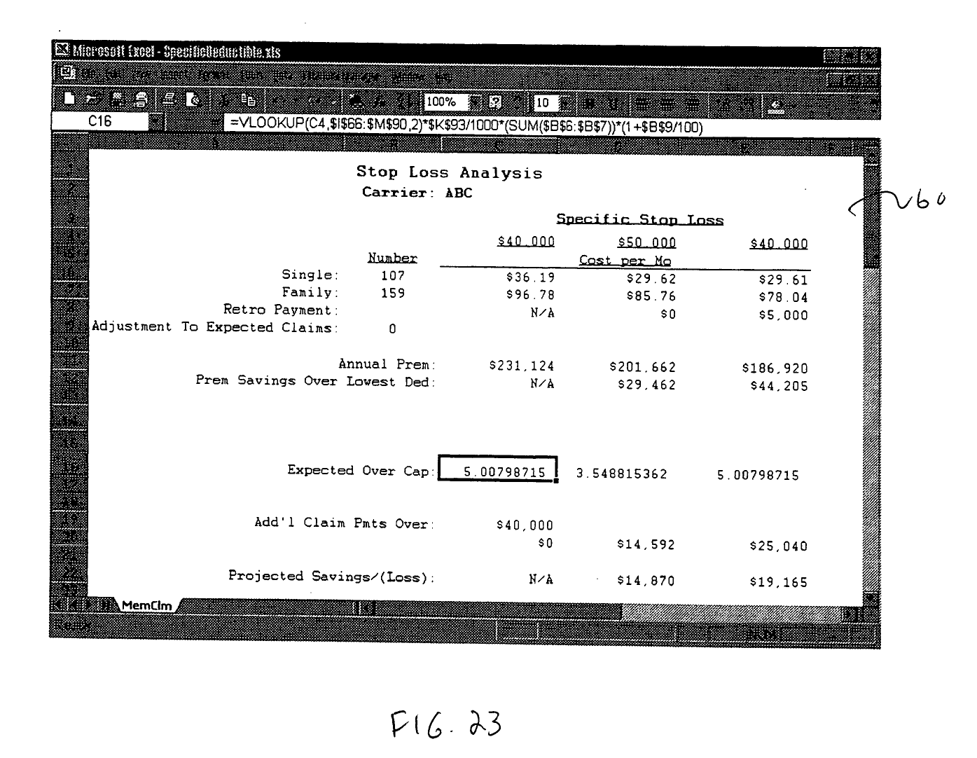

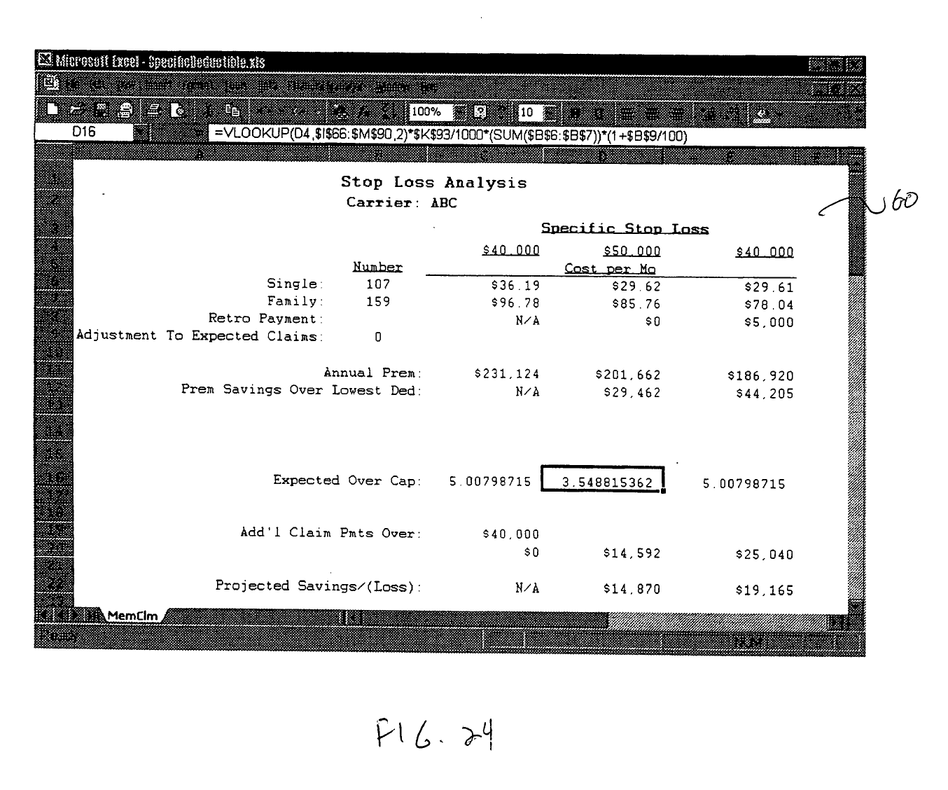

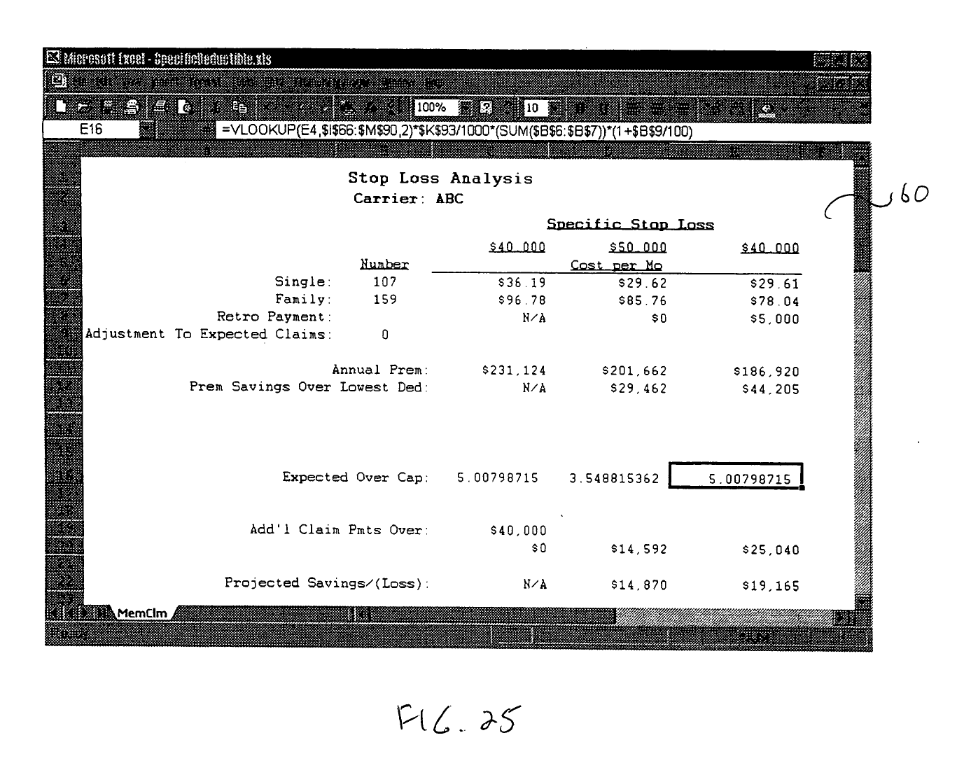

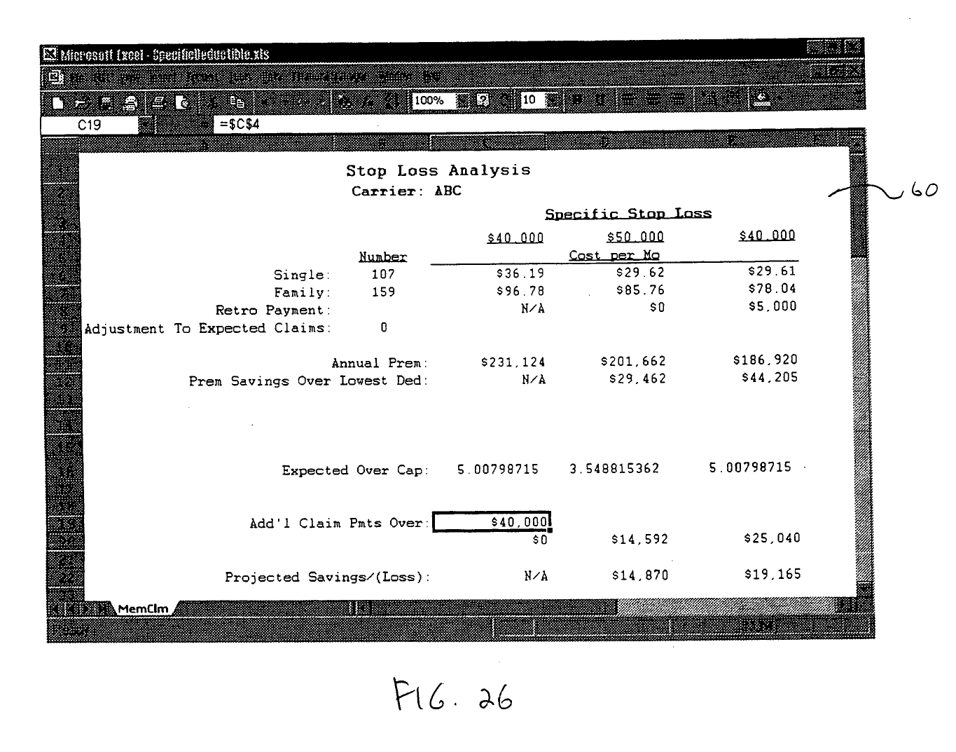

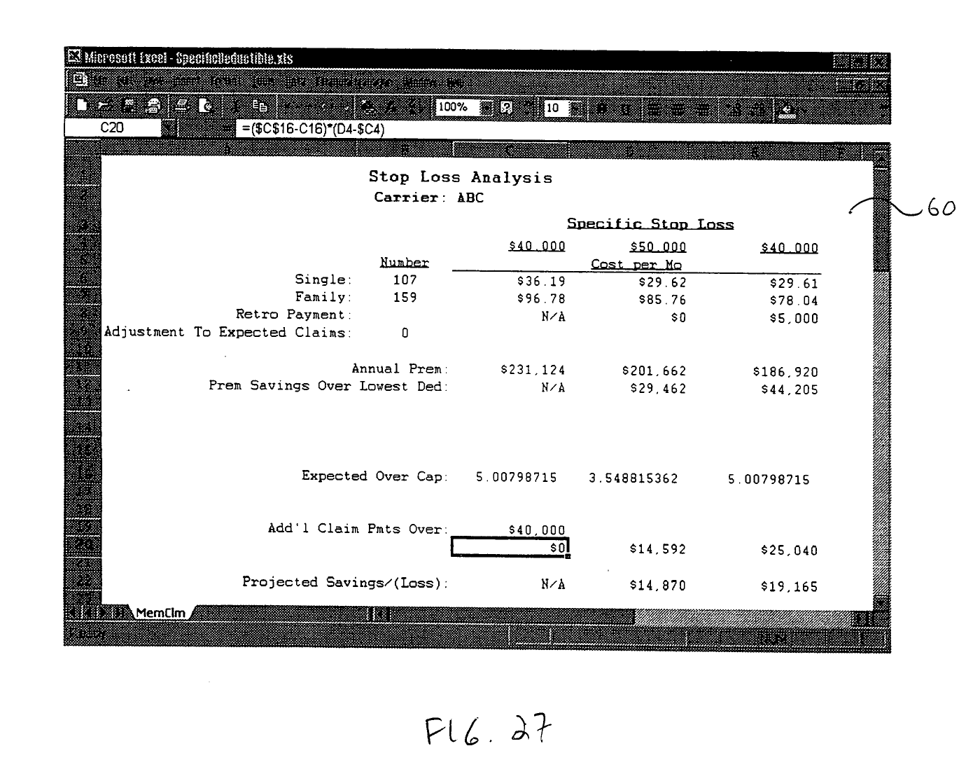

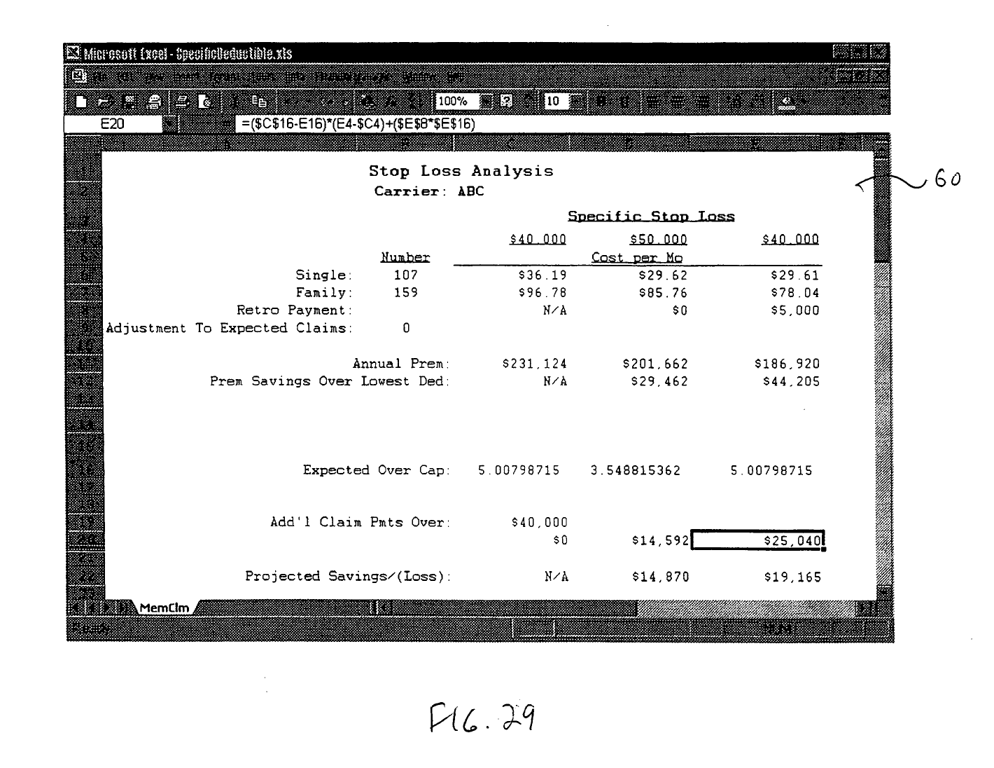

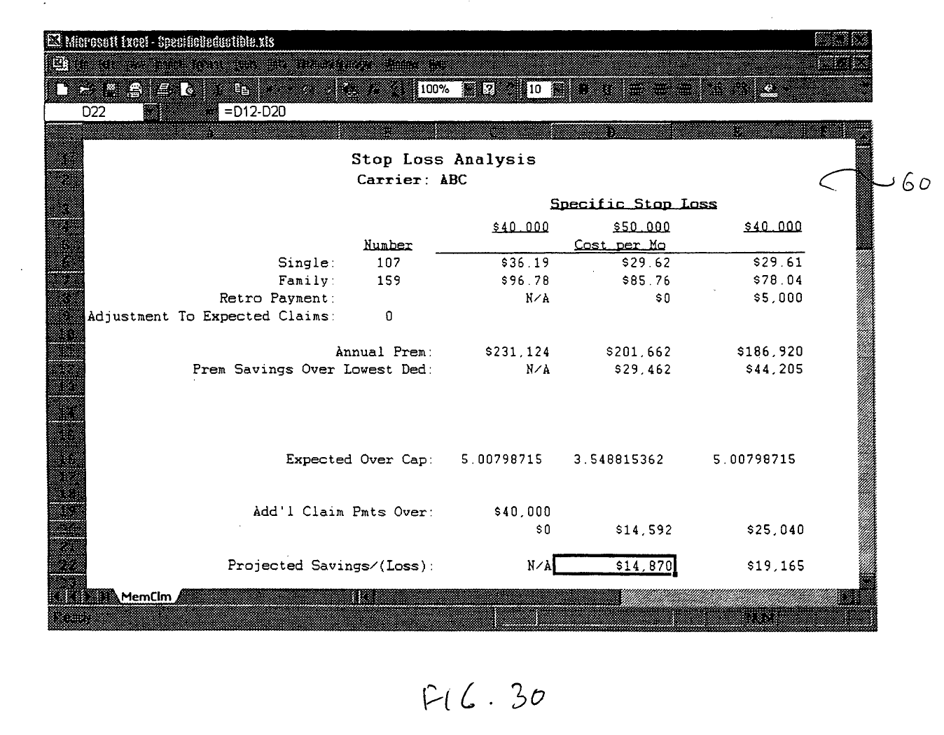

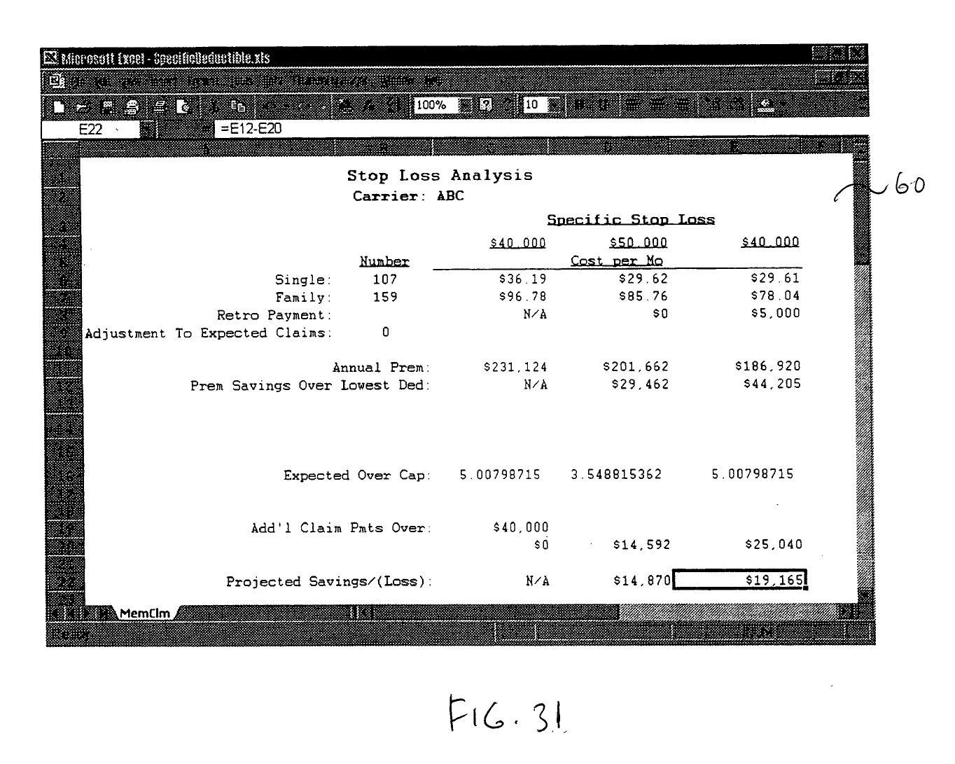

Detailed examples of how these steps are executed are found in FIGS. 5-31, which show one implementation of a method of the present invention. The specific implementation depicted in the screen displays 60 of FIGS. 5-31 is a MICROSOFT EXCEL® spreadsheet. FIGS. 5-31 depict the required information that must be entered into the implementation to determine projected savings. The figures also depict the formulae utilized to determine additional claims and projected savings. As will be readily appreciated, other implementations are possible such as, but not limited to, hand calculations utilizing the previously discussed demographic data and the like.

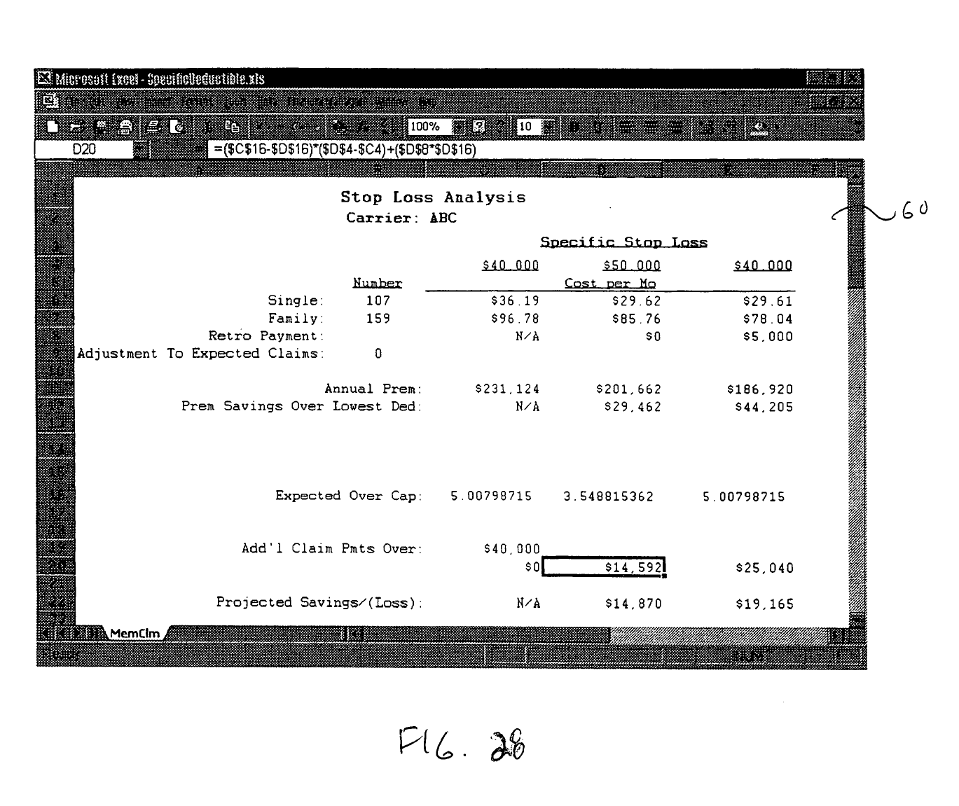

Turning now to FIGS. 28-31, to determine the projected savings for a cap level of $50,000 over the more expensive cap of $40,000, the number of expected losses per one thousand insured units that exceed $40,000 but do not exceed $50,000 must be determined. As will be appreciated, this is accomplished by subtracting the expected losses exceeding $40,000 from the expected losses exceeding $50,000. As shown in FIG. 28, this is the difference between the expected losses per 1,000 insured units at $40,000—5.00798715— and the expected losses per 1,000 insured units at $50,000—3.548815362, i.e., 1.4592. This number of expected losses is then multiplied by the difference between $40,000 and $50,000 i.e., $10,000, to determine expected additional claim payments at the higher cap level. Thus, $10,000×1.4592=$14,592. So, an employer could expect to pay $14,592 if it selects a cap level of $50,000 over the cap level of $40,000. To determine projected savings at this cap level, the additional claims payments are subtracted from the difference in the annual premiums for the two cap levels. Therefore, $14,592 is subtracted from $29,462 which yields a projected savings of $14,870.

It will be readily appreciated that while the system and method of the present invention has been described in connection with analyzing multiple insurance premium quotes from a single insurance carrier at differing stop-loss cap levels, the present invention is not so limited in this regard. That is, the system and method of the present invention may be equally applicable to the analyzing of insurance premium quotes from multiple insurance carriers at differing stop-loss cap levels. Thus, the system and method of the present invention may utilize statistical loss data for the insured units in order to compare the insurance premiums for insurance plans offered by different insurance carriers, each of the insurance carriers offering premiums for differing stop-loss cap levels.

As recited above, the system and method of the present invention permits a factual basis upon which to base a determination as to the best insurance plan (that is, the most appropriate cap level) to purchase, in consideration of historical or statistical loss data. This analysis is equally capable of clarifying the choice between differing cap levels offered by the same insurance carrier, or of clarifying the choice between a first cap level offered by a first insurance carrier, with that of a second cap level offered by a second insurance carrier.

Although the present invention has been described with reference to preferred embodiments, it will be appreciated by those of ordinary skill in the art, that various modifications to this invention may be made without departing from the spirit and scope of the invention.

What is claimed is:

1. A method for optimizing insurance estimates for an insurance plan, said method comprising the steps of:
ascertaining the number of insured units to be covered by said plan;
obtaining premium quotes from an insurance carrier, said premium quotes corresponding to said number of insured units and to a plurality of cap levels of said plan;
obtaining statistical loss data for said insured units; and
applying said obtained statistical loss data to each of said cap levels.

2. The method for optimizing insurance estimates for an insurance plan in accordance with claim 1, further comprising the steps of:
utilizing statistical loss data that reflects demographic data for said insured units.

3. The method for optimizing insurance estimates for an insurance plan in accordance with claim 2, wherein:
said insured units include individual and family insured units.

4. The method for optimizing insurance estimates for an insurance plan in accordance with claim 1, wherein:
said insurance plan is a self-insurance plan.

5. The method for optimizing insurance estimates for an insurance plan in accordance with claim 4, wherein:
said cap levels of said self-insurance plan are stop-loss cap levels.

6. The method for optimizing insurance estimates for an insurance plan in accordance with claim 1, further comprising the steps of:
analyzing an incidence of claims exceeding each of said cap levels, in conformance with said obtained statistical loss data.

7. The method for optimizing insurance estimates for an insurance plan in accordance with claim 6, further comprising the steps of:
determining a potential cost of said claims exceeding each of said cap levels.

8. The method for optimizing insurance estimates for an insurance plan in accordance with claim 7, further comprising the steps of:
comparing said premiums for each of said cap levels with said determined potential cost of said claims that exceed each of said cap levels.

9. The method for optimizing insurance estimates for an insurance plan in accordance with claim 8, further comprising the steps of:
selecting one of said cap levels of said insurance plan in dependence upon said comparison of said premiums for each of said cap levels and said determined potential cost of said claims that exceed each of said cap levels.

10. A method for optimizing insurance estimates for an insurance plan, said method comprising the steps of:
ascertaining the number of insured units to be covered by said plan;
obtaining a first premium quote from a first insurance carrier, said premium quote corresponding to said number of insured units and to a first predetermined cap level of said plan;
obtaining statistical loss data for said insured units; and
applying said obtained statistical loss data to said cap level.

11. The method for optimizing insurance estimates for an insurance plan in accordance with claim 10, further comprising the steps of:
obtaining a second premium quote from a second insurance carrier, said premium quote corresponding to said number of insured units and to a second predetermined cap level of said plan, said first predetermined cap level being different from said second predetermined cap level.

12. The method for optimizing insurance estimates for an insurance plan in accordance with claim 11, further comprising the steps of:
utilizing statistical loss data that reflects demographic data for said insured units.

13. The method for optimizing insurance estimates for an insurance plan in accordance with claim 12, wherein:
said insured units include individual and family insured units.

14. The method for optimizing insurance estimates for an insurance plan in accordance with claim 10, wherein:
said insurance plan is a self-insurance plan.

15. The method for optimizing insurance estimates for an insurance plan in accordance with claim 14, wherein:
said cap levels of said self-insurance plan are stop-loss cap levels.

16. The method for optimizing insurance estimates for an insurance plan in accordance with claim 11, further comprising the steps of:
analyzing an incidence of claims exceeding each of said first and said second cap levels, in conformance with said obtained statistical loss data.

17. The method for optimizing insurance estimates for an insurance plan in accordance with claim 16, further comprising the steps of:
determining a potential cost of said claims exceeding each of said first and said second cap levels.

18. The method for optimizing insurance estimates for an insurance plan in accordance with claim 17, further comprising the steps of:
comparing said premiums for said first and said second cap levels with said determined potential cost of said claims that exceed each of said first and said second cap levels.

19. The method for optimizing insurance estimates for an insurance plan in accordance with claim 18, further comprising the steps of:
selecting one of said first and said second cap levels in dependence upon said comparison of said premiums for said first and said second cap levels and said determined potential cost of said claims that exceed each of said first and said second cap levels.

20. A method for optimizing insurance estimates for a stop-loss insurance plan, said method comprising the steps of:
ascertaining the number of insured units to be covered by said stop-loss insurance plan;
obtaining premium quotes from an insurance carrier, said premium quotes corresponding to said number of insured units and to a plurality of cap levels of said stop-loss insurance plan;
obtaining statistical loss data for said insured units;
applying said statistical loss data at each of said cap levels to determine an incidence of claims exceeding each of said cap levels; and
selecting one of said cap levels of said stop-loss insurance plan in dependence upon said comparison of said premiums for each of said cap levels and said determined incidence of said claims that exceed each of said cap levels.
